(19) United States
(12) Patent Application Publication
(10) Pub. No.: US 2016/0070698 A1
(43) Pub. Date: Mar. 10, 2016

(54) Database Management System Tools for An Automated Work to Stage Process

(71) Applicant: Total System Services, Inc., Columbus, GA (US)

(72) Inventors: Jeffrey D. Cable, Hamilton, GA (US); LaMonia LaToya Whitaker, Columbus, GA (US)

(21) Appl. No.: 14/477,259

(22) Filed: Sep. 4, 2014

(51) Int. Cl. G06F 17/30

(52) U.S. Cl. CPC G06F 17/3012

(57) ABSTRACT

A computer compares an old database source file and new database source file to identify one or more changes between the old and the new database source files. Then, the computer generates one or more keys for each identified change. The keys are sorted into files that are then used to build a first dataset that includes at least one or more execution members. The execution members are initially grouped into one or more groups based on an order of execution of jobs associated with the one or more execution members. Then, within each group, the computer separates execution members that executable in parallel. Further, the computer builds a second dataset that includes at least a submit member for each group of execution members that executable in parallel. The submit member comprises a set of instructions to submit, for execution, all execution members of a group in parallel.

### FIELD OF INVENTION

This invention relates generally to databases, and more particularly, to a system, apparatus and method of a database management system tool for automated work to stage process.

### BACKGROUND

Businesses use database systems to store and manipulate information. Typically, the database systems comprise both a database and a database management system for maintenance of the database. The database management system includes a collection of programs referred to as database management system tools (herein ‘database management tools’). The database management tools can be used by a database administrator to maintain a database system or otherwise support database management system operations such as sorting, organizing, selecting, modifying, and extracting data from the database. In particular, the database management tools can generate instructions that are used for implementing the various database maintenance operations mentioned above. Instructions for managing data must be written in the specific computer language for the host platform. For example, IBM's IMS (Information Management System) database system resident on an IBM mainframe computer would receive instructions in Job Control Language (JCL) to run batch data management processes.

Conventional database management tools may generate instructions that further need to be manipulated by a user for an efficient implementation of the operations associated with database management. For example, the conventional database management tools may not generate a complete set of instructions needed for implementing a specific database change, and the user may need to add additional instructions. In another example, the conventional database management tools may generate instructions that are not needed for implementing a specific database change, and the user may need to delete the unnecessary instructions. Accordingly, in order to operate the conventional database management tools a user requires prior technical and in-depth knowledge of database systems and specific computer language associated with the instructions. In addition, since the user has to make additional manipulations to database management tool's output, conventional database management tools are not user-friendly. Further, conventional database management tools fail to identify instructions that can be grouped together for execution. Therefore, a user may need to read each instruction and submit each instruction for execution one at a time which may be both time intensive and cost intensive. Further, the process may be prone to inevitable human errors resulting from manual intervention of the user, such as skipping an instruction or submitting an instruction at a wrong time. In addition, conventional database management tools fail to identify instructions that can be executed outside of an outage window. Outage window is a time period where the database is taken offline for maintenance. Accordingly, during the outage window the database may be unavailable to any other system that is coupled to the database. Thus, operations of the other system coupled to the database may be stalled till the database is brought back online. Failure to identify instructions that can execute outside of the outage window results in a comparatively larger outage time and an inefficient use of the outage time. Thus, there is a need for a technology that addresses the above-mentioned deficiencies.

### SUMMARY

The present disclosure can address the above-described needs by use of database management system tools for implementing an automated work to stage process. For explanatory purposes, the present disclosure describes the database management system tool in relation to the IBM IMS database. However, one of ordinary skill in the art can understand and appreciate the database management tool described herein can be equally applicable to other hierarchical databases and/or databases having any other appropriate structure, without departing from a broader scope of this disclosure.

In an exemplary embodiment, a computer receives an old database source file and a new database source file as input. The old database source file may represent a current structure of the database and the new database source file may represent a new structure of the database that results from changes made to the current structure of the database. For example, assume that an enterprise ABC's current database structure includes 10 areas and 20 segments. As the enterprise ABC's business expands, enterprise ABC may add new client relations and may decide to add an additional product line for the new clients. Accordingly, enterprise ABC's current database needs to be changed to include data regarding the new clients and the new product line. The change may result in additional areas and segments within the current database. In said example, assume the change results in 1 additional area and 2 additional segments. Accordingly, enterprise ABC's new database structure includes 11 areas and 22 segments. In said example, a database administrator may input the old database source file identifying the current database structure having 10 areas and 20 segments and the new database source file identifying the new database structure having 11 areas and 22 segments to the computer.

Once the computer receives the old and new database source files, the computer performs a line by line comparison between the old database source file and the new database source file to identify any changes in the database. The changes to the database can include, but is not limited to, addition of new areas and/or segments, deletion of areas and/or segments, compressions, installing brand new databases, areas and/or segments, and so on. Upon identifying that there is a change, the computer determines the level at which the change has occurred and the type of the change. For example, the computer can identify if the change is at a database level, and area level, and/or a segment level. Further, in said example, the computer can identify if the change is deletion change, an addition based change, a compression change, and so on. In association with identifying the type and level of change, the computer runs one or more queries as part of the comparison. The queries may or may not be nested. For example, first, the computer may query if the change is a database level change. Then based on the response, the computer may query if the change is a deletion change. Further, based on the response of the second query, the computer may run a third query that determines if unload and reload operations are to be performed in association with the deletion change, and so on. The computer may assign a key to each response of each query. In some embodiments, responses to some queries may not be assigned a key.

Accordingly, the comparison and identification of the type and level of change generates one or more keys associated with each identified change. In other words, responsive to identifying the type and level of change, the computer flags each change with one or more keys. A key may be a four character key, such as COMP for compression change. One of ordinary skill in the art can understand and appreciate that the key can take any other appropriate form, such as an n digit key, where ‘n’ is less than 4 or ‘n’ is more than four, or an alphanumeric key, and so on, without departing from a broader scope of this disclosure.

Responsive to flagging the changes with one or more keys, the computer sorts each key into one or more files. Each key can exist in one or more files, and each file can have one or more keys. Once the keys are sorted into files, the computer provides the files as input to a parameter library that includes one or more parameters, i.e., skeleton JCL's. A skeleton JCL may refer to a template JCL's containing variables. The files provided as input to the parameter library passes values of variables and these values are embedded into the JCL, thereby creating dynamic JCL's. Using the files with keys that are provided as input to the parameter library, the computer builds a first execution JCL dataset. In particular, for each parameter in the parameter library, the computer determines if one or more of the input files provide values necessary for creating dynamic JCL's for the respective parameter. That is, based on a logic associated with each parameter, the computer checks one or more of the input files for a certain number and type of keys. If the certain number and type of keys are present in the one or more input files, then, the computer outputs dynamic JCL's (herein ‘execution JCL's’) associated with the respective parameter into the first execution JCL dataset.

In particular, the first execution JCL dataset includes at least a detail member that provides a summary of all the changes, and one or more execution member that includes a description of the jobs that must run to implement each change. Each execution member includes one or more jobs and each job includes one or more execution JCL's. While building the first execution JCL dataset, the computer groups the one or more execution members in an order of execution, i.e., jobs that can be executed prior to an outage, jobs that can be executed after the outage, and jobs that can be executed during the outage. After grouping the execution members in an order of execution, the execution members in each group are further separated based on jobs that can be run at the same time. The grouping based on order of execution and based on jobs that can be executed in parallel results in an efficient usage of the outage time period by minimizing the outage time period and by avoiding execution of instructions that can be executed outside of the outage time period from being executed during the outage time period.

For example, the first execution JCL dataset may include 20 execution members of which 5 may include jobs that can be executed before the outage (group 1), 5 may include jobs that can be executed during the outage (group 2), and 10 may include jobs that can be executed after the outage (group 3). In said example, the 10 execution members grouped for execution after outage may include 8 jobs of which 6 can be executed at the same time, i.e., in parallel. Accordingly, the computer first groups the 20 execution members into 3 groups based on order of execution. Then, within the group for execution after the outage, i.e., group 3, 6 jobs may be grouped for parallel execution at a time period after the outage.

Once the first execution JCL dataset is built, the computer creates a second execution JCL dataset with an additional node of ‘.sub’ added to the grouped execution members in the first execution JCL dataset. The second execution JCL dataset includes at least a submit member and a checklist member. The submit member includes JCL statements to submit for execution of all jobs of the first execution JCL dataset that can be executed in parallel. Continuing with the above mentioned example of the first execution JCL dataset grouping, group 3 includes 8 jobs out of which 6 can be run in parallel. Accordingly, the second execution JCL dataset may include one submit member for the 6 jobs that can be run in parallel. Assuming that the other 2 jobs out of the 8 jobs cannot be executed in parallel, for group 3, the second execution JCL dataset may include 3 submit members, one for submitting the 6 jobs in parallel, one for submitting one of the remaining 2 jobs that cannot be run in parallel, and one for submitting the other one of the remaining 2 jobs that cannot be run in parallel. The creation of submit members allows a user to go into only one member and submit all jobs that can run together from a single spot instead of going into each member and submit the jobs one at a time. The submit members saves time and limits mistakes such as skipping a job or submitting a job from another group. The checklist member of the second execution JCL dataset includes a listing of all members that needs to be run. Each execution member may have a 3-character identifier prefix, and the grouping and separation of the execution members as described above is based on the 3-character identifier.

### BRIEF DESCRIPTION OF THE FIGURES

Example embodiments are illustrated by way of example and not limitation in the figures of the accompanying drawings, in which:

FIG. 1 illustrates an example an operating environment of the database management system tools for an automated work to stage process, according to certain exemplary embodiments.

FIG. 2A illustrates an example standalone hardware implementation of the database management system tools FIG. 1, according to certain exemplary embodiments.

FIG. 2B illustrates example software architecture of the database management system tools, according to certain exemplary embodiments.

FIG. 3 illustrates example software architecture of the database management system tools specific to a work to stage process, according to certain exemplary embodiments.

FIG. 4 is a flow chart that illustrates the automated work to stage process, according to certain exemplary embodiments.

FIG. 5 is a flow chart that illustrates a process of generation of execution JCL files in the automated work to stage process of FIG. 4, according to certain exemplary embodiments.

FIG. 6 is a flow chart that illustrates a process of generation of first execution JCL dataset in the automated work to stage process of FIG. 5, according to certain exemplary embodiments.

FIG. 7 illustrates an example screen image depicting a primary selection screen, according to certain exemplary embodiments.

FIGS. 8A-8D (collectively ‘FIG. 8’) illustrates an example screen image depicting a work to stage database maintenance screen, according to certain exemplary embodiments.

Many aspects of the invention can be better understood with reference to the above drawings. The elements and features in the drawings are not to scale; emphasis is instead being placed upon clearly illustrating the principles of example embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION

Exemplary embodiments of the system, apparatus, and method of a database management system tool for automated work to stage process are provided. In particular, the following disclosure focuses on automated work to process type maintenance associated with a database, such as an IBM IMS database. Although this detailed description focuses on IBM's IMS database system, one of ordinary skill in the art would appreciate that these methods and systems can apply to other database systems. Before discussing the embodiments directed to the system, apparatus, and method of a database management system tool for automated work to stage process, it may assist the reader to understand the various terms used herein by way of a general description of the terms in the following paragraphs.

The term ‘outage time period,’ as used herein may generally refer to a period of time when a database system is unavailable. The term ‘outage time period,’ may also be interchangeably referred to as downtime.

The term ‘database source file,’ as used herein may generally refer to any appropriate file that represents the structure of a database. The old database source file may refer to a current structure of a database and the new database source file may refer to an updated/new version of the current structure of the database. The new database source file may vary from the old database source file if there are any changes made to the current structure of the database, for example, addition or areas, deletion of segments, etc.

The term ‘skeleton JCL,’ as used herein may generally refer to any appropriate JCL template that another program can use with certain parameters and create dynamic JCL on the fly or at run time. The term ‘submit’ as used herein may generally refer to releasing jobs or instructions for execution.

The term ‘order of execution,’ as used herein generally refers to the sequence associated with execution of instructions, e.g., JCL instructions. Example order of sequence can include, execution before an outage time period, execution during an outage time period, and execution after an outage time period.

The term ‘instructions,’ as used herein may generally refer to any appropriate command that is executable by a computer. Instructions for managing data must be written in the specific computer language for the host platform. For example, and IBM IMS system resident on an IBM mainframe computer would receive instructions in Job Control Language (JCL) to run batch data management processes. Typically, these instructions are not written in plain English, that is, these instructions are not written in the normal syntax of a written or spoken sentence. Instead, these instructions have a defined syntax, dependent on the language being used. For example, JCL requires an 80-byte record with information on a single line. The information includes an identifier field, a name field, an operation field, and operand field, and a comment field.

The term ‘job,’ as referred to herein may generally refer to a collection of instructions. For example, a job may be a collection of JCL statements or JCL instructions. In one example embodiment, jobs are executable by any appropriate data processing device to implement a change to a database. A collection of jobs may form a ‘member’, and a collection of one or more members may form a ‘dataset’.

An example system of database management system tool for automated work to stage database management process includes a computer that is configured to receive an old database source file and a new database source file associated with a database, process the old database source file and the new database source file, and output one or more datasets of instructions representative of jobs for implementing changes to the database, if any. In particular, the instructions in the one or more dataset may be separated into groups representing jobs that can be executed prior to an outage time period, during an outage time period, and after an outage time period. Further, instructions within each group are further separated based on jobs that can be executed contemporaneously or in parallel. Then, the computer generates another set of instructions for submitting instructions within each instruction group for execution in parallel. The computer can present the one or more dataset to a user to assist the user in implementing changes in the database, if any. The grouping of instructions into jobs that can be executed outside the outage time period and during the outage time period aids in minimizing the outage time period and to make efficient use of the outage time period. Further, the grouping of instructions those are executable in parallel and using one submission for each grouped instruction set (comprises instructions that are executable in parallel) instead of one submission per instruction limits the number of jobs that the user has to submit and increases performance.

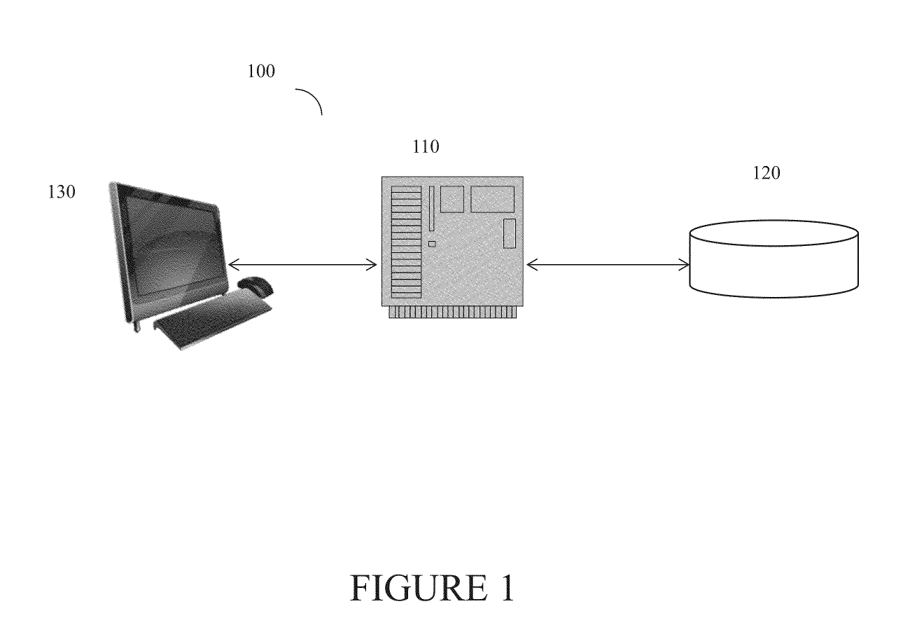

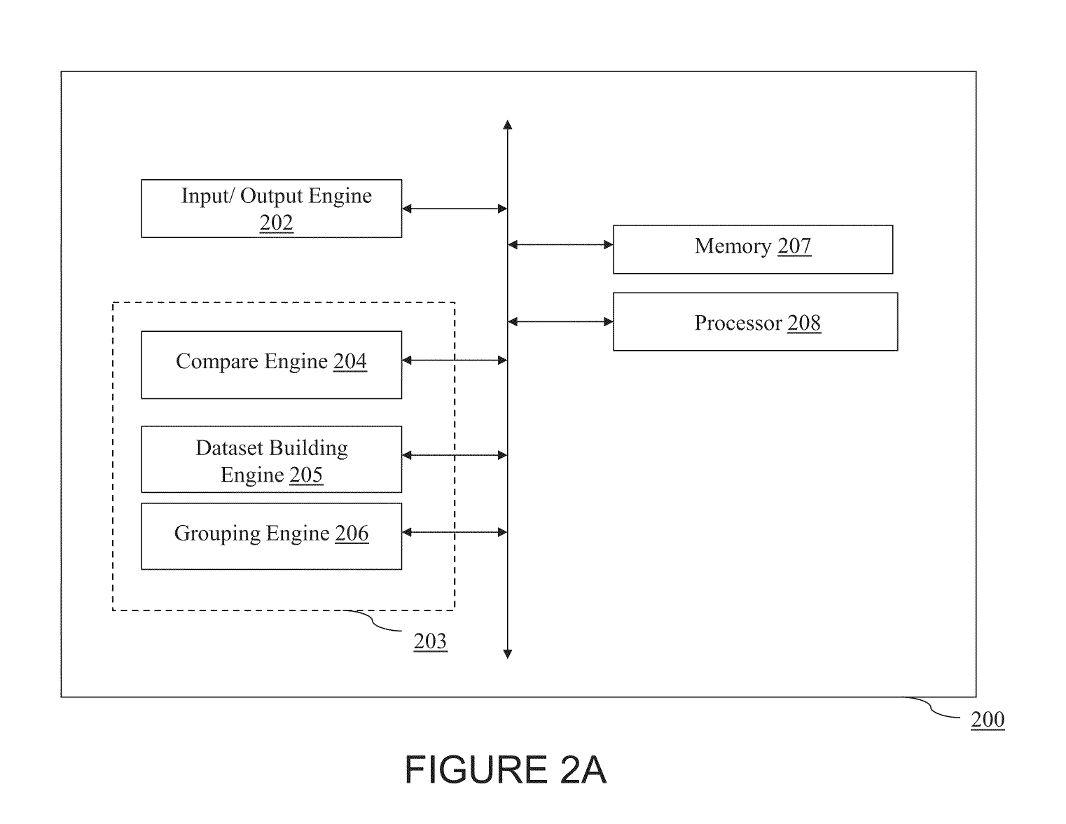

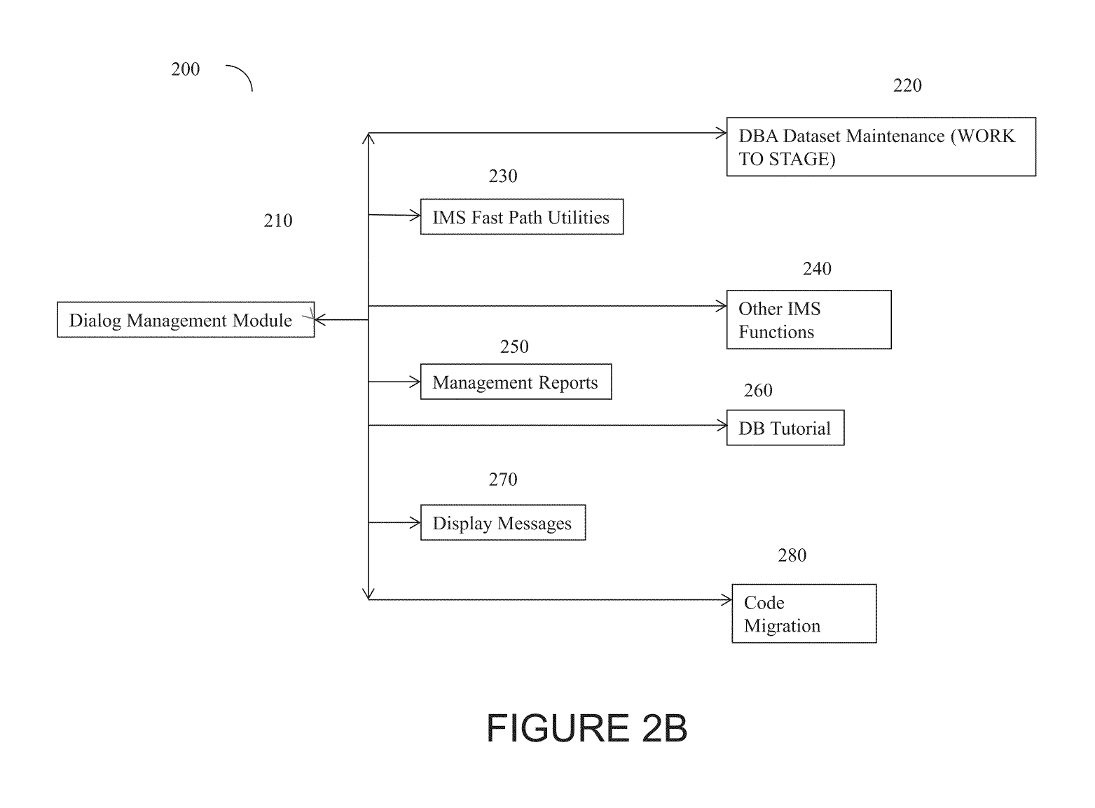

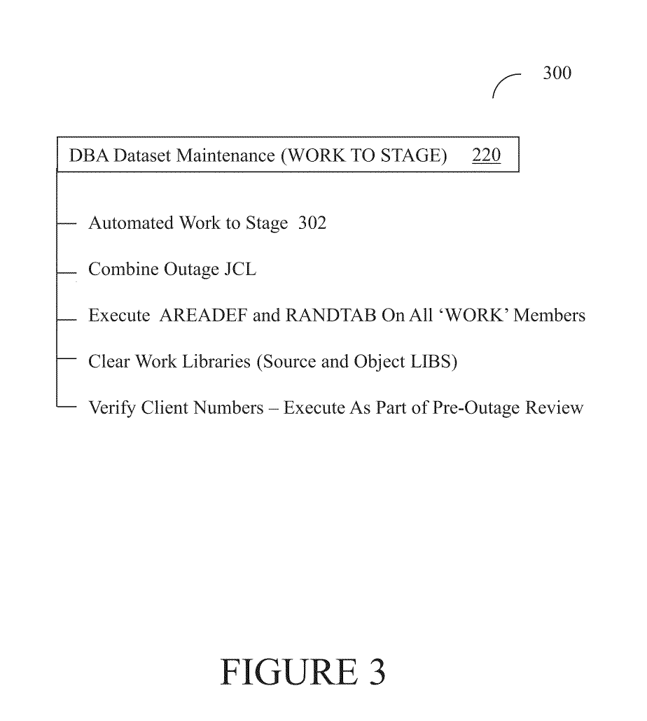

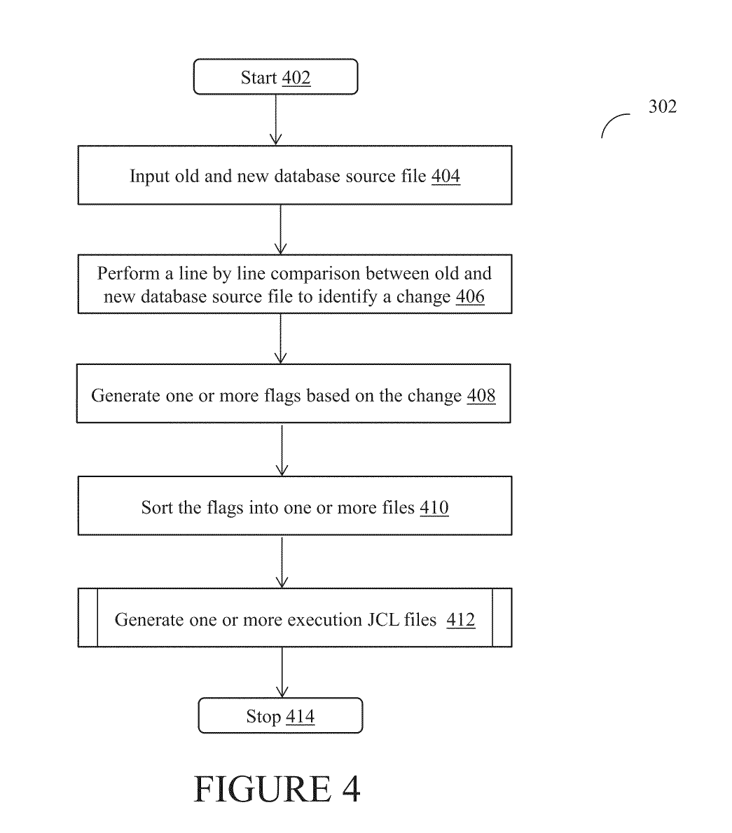

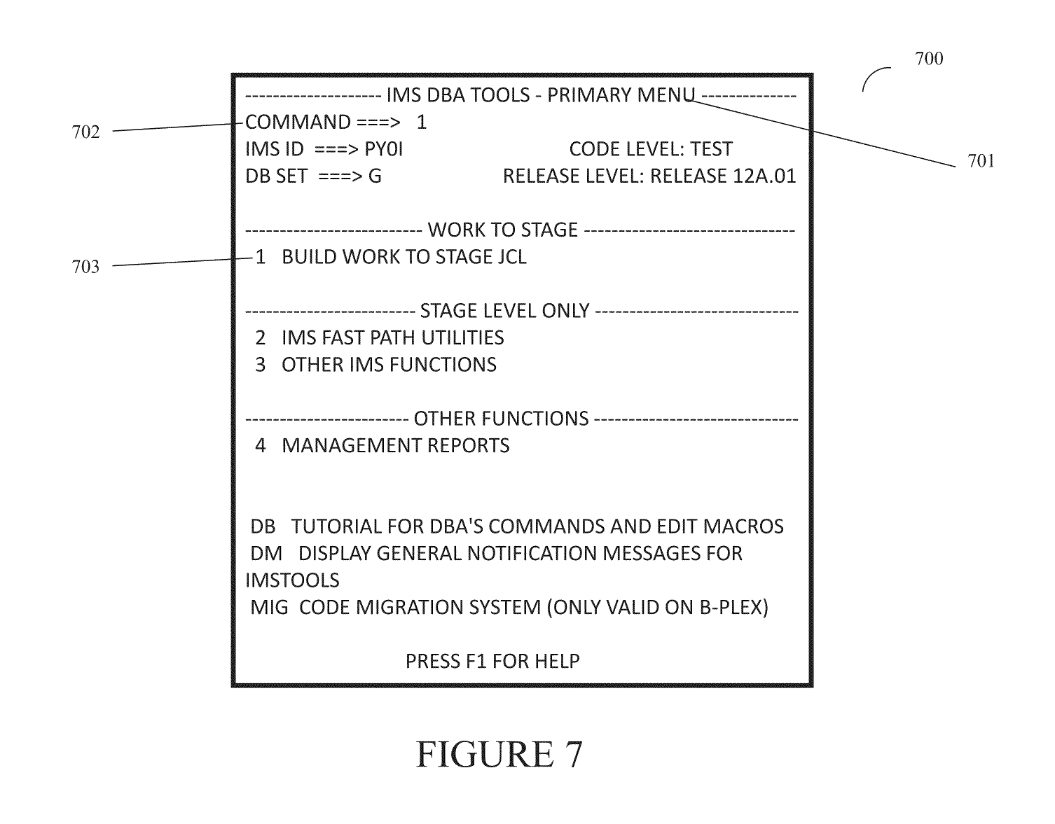

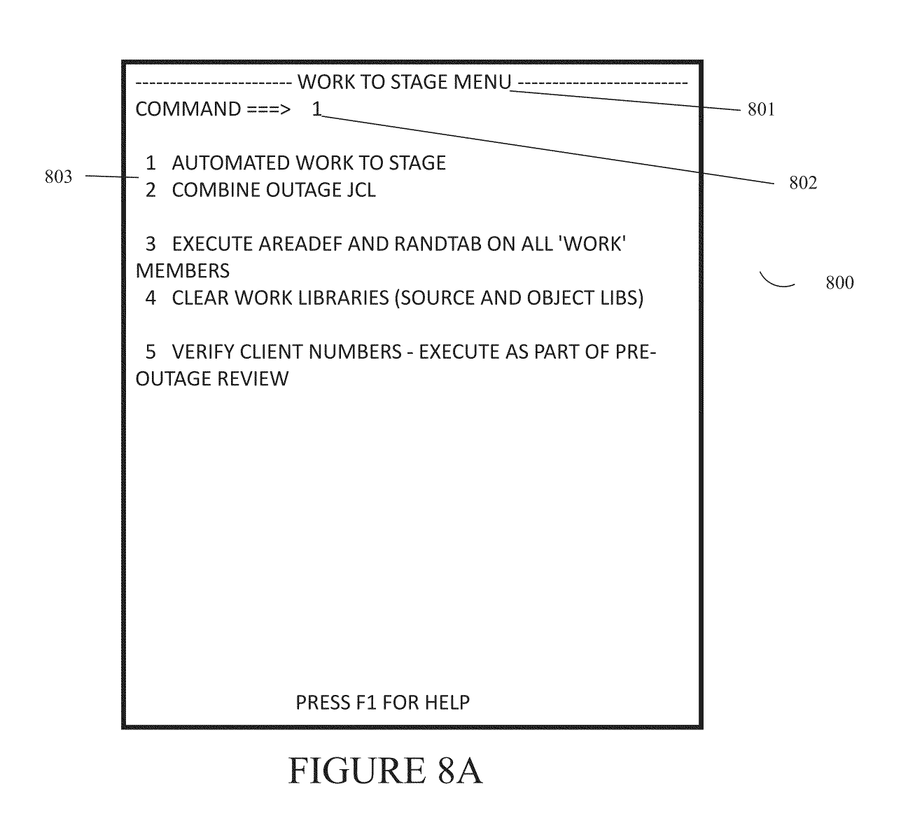

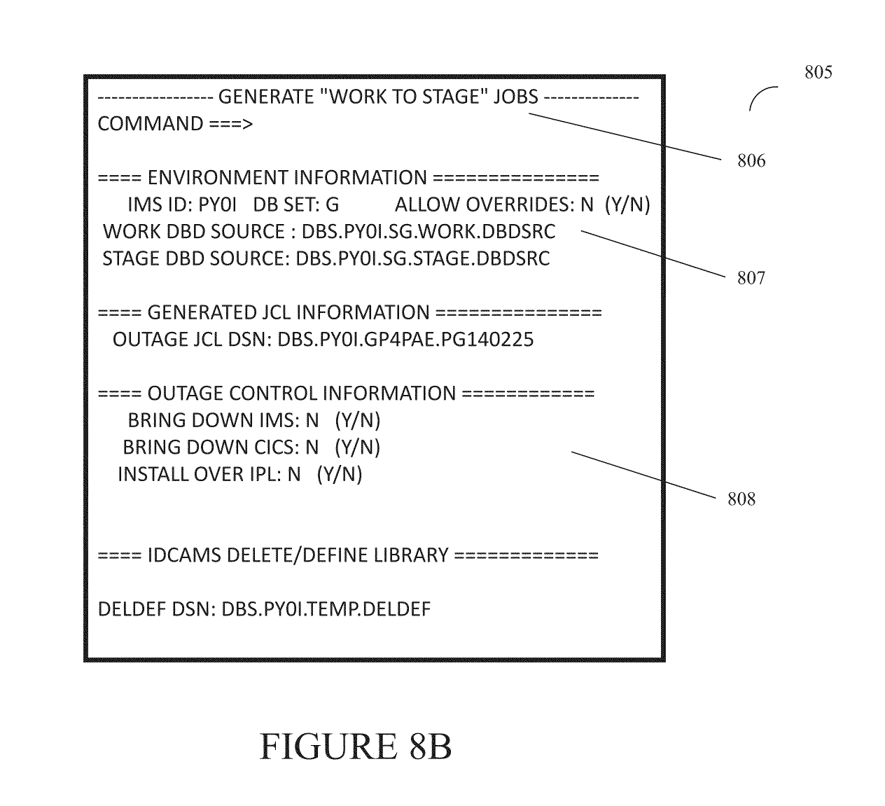

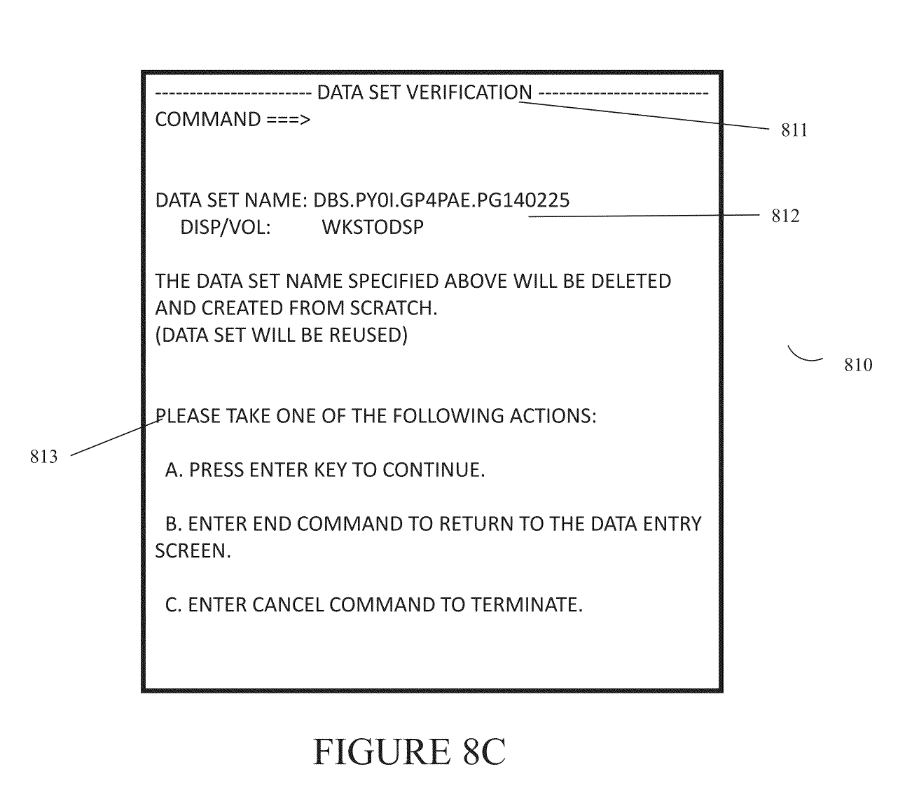

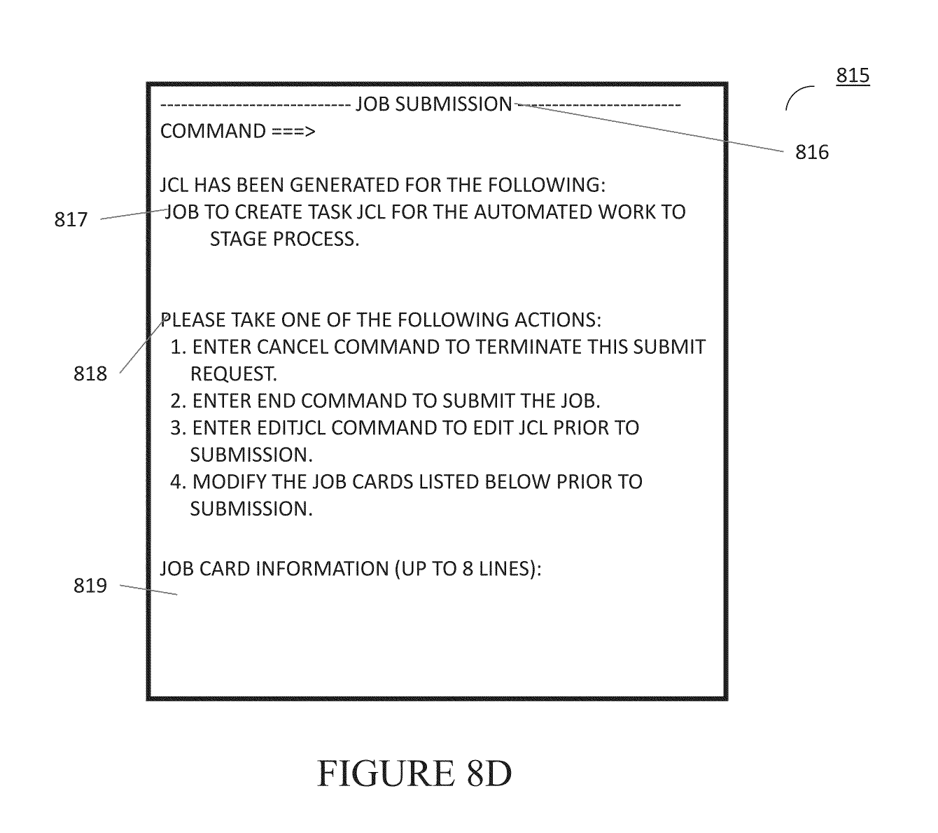

Technology associated with database management system tools for automated work to stage database management process will now be described in greater detail with reference to FIGS. 1-8, which describe representative embodiments of the present invention. First, FIG. 1 will be discussed in the context of describing a representative operating environment associated with the database management system tools according to certain exemplary embodiments of the present invention. FIGS. 2 and 3 will be discussed, making exemplary reference back to FIG. 1 as may be appropriate or helpful. Further, the FIGS. 4-6 will be discussed, making exemplary reference back to FIGS. 1-3 and reference to FIGS. 7-8 as may be appropriate or helpful.

The following paragraphs describe various embodiments of the method, apparatus, and system associated with database management system tools for automated work to stage database management process. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

Further, the present invention may be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention.

Moving to FIG. 1, this figure illustrates an example an operating environment of the database management system tools for an automated work to stage process, according to certain exemplary embodiments. In particular, FIG. 1 illustrates a mainframe computer 110, a data store 120, and a terminal 130.

Referring to FIG. 1, a database and management system, such as an IBM IMS database management system, resides on a mainframe computer 110. The data associated with the database resides in a data store 120, which is logically connected to the mainframe computer 110. The mainframe computer 110 may service a variety of programs including programs that use data from the database store 120. The mainframe computer 110 is accessed using a terminal, such as a terminal 130. The terminal 130 enables a user to provide input and instructions to programs resident on the mainframe computer 110 and enables the user to receive information from the mainframe computer 110. Example input provided to the mainframe computer 110 can include the old and new database source files. Further, example information received from the mainframe computer 110 may include the first and second datasets comprising jobs grouped based on an order of execution and instructions for submitting the jobs that can be executed in parallel for implementing changes to a database structure, i.e., one submission per group of jobs that can be executed in parallel. One of ordinary skill in the art can understand and appreciate that the example inputs and outputs mentioned above are not limiting, and any other appropriate inputs and outputs associated with database management are not outside the broader scope of this description.

Further, one of ordinary skill in the art would understand that other computer platforms could host a database and database management system. For example, the database and database management system could reside on a network server (not shown) that is part of a local area or wide area network. Similarly, the database management system may reside on a single computer, such as mainframe computer 110, and the database reside in distributed data stores (not shown), including data stores on different computer platforms. Also, the mainframe computer 110 or other host computers could be accessed by a variety of hardware other than terminal 130, such as personal computer (not shown) running terminal emulation software. Indeed, one of ordinary skill in the art would understand that a variety of computer systems may be used, provided that a user has access to the necessary database management tools and can manage the data stores using those tools.

The database management tools may either be implemented as hardware, software, or a combination of both. In one example, the database management system tools may be a set of instructions that are executable by a processor to perform various steps of automated work to stage process. The set of instructions may be embodied on a non-transitory computer readable storage medium which can be in concert with a computer for executing the automated work to stage operations. For example, a database management system tools may be stored in a compact disc and a user can download the database management system tools to the user's personal computer device or terminal 130 that is communicably and logically coupled to the mainframe computer 110. Alternatively, the database management system tools may be stored in a cloud server and the user can download the database management system tools by communicably coupling the user's computing device to the cloud server. Further, the database management system tools may be stored in a memory of the mainframe computer 110 and may have a client side application that is downloadable by the user on the user's computing device. The database management system tools stored in the mainframe computer 110 is also directly accessible through terminal 130.

In another example, the database management system tools may be implemented as a standalone hardware circuitry including one or more processors and memories that are configured to execute the operations associated with the database management system tools, e.g., automated work to stage process. In yet another example, the database management system tools may be implemented as a hardware circuitry within the mainframe computer 110.

In either case, the database management system tools is configured to receive an old database source file and a new database source file associated with a database, process the old database source file and the new database source file, and output one or more datasets of instructions representative of jobs for implementing changes to the database, if any. As described above the instructions are grouped based on an order of execution. Further, the instructions within each group are separated based on which instructions can be executed in parallel. In addition, the database management system tools is configured to generate another set of instructions for submitting the grouped instructions for execution, where the execution of the grouped instructions occur in parallel and each submission is associated with a respective group of instructions that can be executed in parallel. The operation of the database management system tools will be described in greater detail in association with FIGS. 4-8 and a hardware implementation and software architecture of the database management system tools will be described in greater detail below in association with FIG. 2.

Turning to FIG. 2A, this figure illustrates an example standalone hardware implementation of the database management system tools FIG. 1, according to certain exemplary embodiments. In particular, FIG. 2A illustrates a database management system tools server 200, input/output engine 202, a primary decision making engine 203 that comprises a compare engine 204, a dataset building engine 205, and a grouping engine 206, a processor 207, and a memory 208.

The database management system tools server 200 may be implemented using one or more data processing devices. Further, the database management system tools server 200 may be implemented as a distributed server system where the operations of the database management system tools server 200 may be distributed between one or more data processors and/or a centralized server system where the operations of the database management system tools server 200 may be handled by a single data processor.

As illustrated in FIG. 2A, the database management system tools server 200 may include a processor 208. The processor 208 may be a multi-core processor. In another embodiment, the processor 208 may be a combination of multiple single core processors. In one embodiment, the database management system tools server 200 can include a memory 208 coupled to the processor 208. The memory 207 may be non-transitory storage medium, in one embodiment, and a transitory medium in another embodiment. The memory 207 can include instructions that may be executed by the processor 208 to perform operations of the database management system tools server 200. In other words, operations associated with the different engines of the database management system tools server 200 may be executed using the processor 208.

The database management system tools server 200 includes an input/output engine 202 that is configured to enable communication to and from the database management system tools server 200. In particular, the input/output engine 202 is configured to receive user input which may include, but is not limited to, user selection based on a selection menu outputted by the input/output engine 202 for interaction with the mainframe computer 110, an old database source file and a new database source file. In response to receiving the old database source file and the new database source file, the database management system tools server 200 may generate one or more datasets comprising instructions for implementation of changes to a database associated with the old and new database source file, if any. The generated one or more dataset may be output by the input/output engine 202 of the database management system tools server 200 for presentation to a user.

In particular, upon receiving the old database source file and the new database source file, the input/output engine 202 may be configured to manipulate the inputted files to get them into a desired format to be processed by the primary decision making engine 203. Once the inputted files are formatted, the input/output engine 202 forwards the files to the compare engine 204 of the primary decision making engine 203.

The compare engine 204 may be configured to perform a line by line comparison of the old database source against the new database source file to identify a change. Further, the compare engine 204 may be configured to determine the level of the change, such as database level, area level, or segment level, and the type of change through a series of queries. Further, the response to each query may be marked using a label or key that is representative of the changes. Accordingly, each change may result in one or more keys or labels. Responsive to generating one or more keys associated with each identified change, the compare engine 204 sorts the one or more keys into one or more files. Once the keys are sorted into files, each file is provided as input to a parameter library that includes a collection of skeleton JCL's. For each skeleton JCL, the compare engine 204 may be configured to check for the presence of one or more files and keys associated with the files. If the files and keys searched in association with a skeleton JCL exist, then, the compare engine 204 communicates with the dataset building engine 205 to output JCL statements associated with the skeleton JCL into a first dataset, i.e., first execution JCL dataset. On the contrary, if the files and keys searched in association with the skeleton JCL do not exist, then, the execution JCL dataset will not be created.

Once the first dataset, i.e., first execution JCL dataset is built, the dataset building engine 205 may be configured to communicate the first execution JCL dataset with the grouping engine 206. The first execution JCL dataset may include at least a details member that provides a summary of all the changes and/or one or more execution members that describe jobs created specific to each change being implemented. An execution member may include one or more jobs, and each job may include one or more JCL statements. Further, each execution member may include a 3-character identifier.

Upon receiving the first executable JCL dataset, the grouping engine 206 may be configured to group the execution members of the first execution JCL dataset based on an order of execution of the jobs in the execution members. The grouping engine 206 is configured to identify the order of execution of the jobs based the first character of the 3-character identifier. Accordingly, the execution members may be grouped into execution members having jobs that can be run while the environment is still available for processing, execution members having jobs that can be run while the environment is unavailable, and execution members having jobs that can be run during environment back up following outage. Once the execution members are grouped based on the order of execution as described above, the execution members within each group are further separated based on execution members having jobs that can be run at the same time or in parallel.

Responsive to grouping the execution members in the first execution JCL dataset, the grouping engine 206 may communicate with the dataset building engine 205 to generate a second dataset, i.e., a second execution JCL dataset based on the first execution JCL dataset. To build the second execution JCL dataset, the dataset building engine 205 may be configured to add a ‘.sub’ node to the first execution JCL dataset. The second execution JCL dataset may include at least one or more submit member and/or a checklist member that lists all the submit members that need to be run. Each submit member may include JCL statements to submit execution members of the first execution JCL dataset for execution in parallel. That is, one submit member per group of execution members that can be executed in parallel may be generated by the dataset building engine 205. Accordingly, to execute jobs of the first execution JCL dataset that can be executed in parallel, a user does not have to go through and execute each job one by one. Instead, the user can go to the submit member that is specifically associated with the group of execution members having jobs that are executable in parallel and submit all the execution members in the group in parallel. For example, if there are 12 jobs that are executable in parallel, one submit member will be created for the 12 jobs. Accordingly, the user can go to one submit member to execute all the 12 jobs in parallel instead of going through 12 separate jobs and making 12 individual submission for execution of the 12 jobs. This limits the number of jobs that the user has to submit for implementation of the database change which increases performance. Software architecture of the database management tools will be described below in greater detail, in association with FIG. 2B.

FIG. 2B illustrates example software architecture of the database management system tools, according to certain exemplary embodiments. In one example embodiment, the database management system tools may be implemented using one or more programs written in COBOL language. For example, each engine 202-208 of FIG. 2A may be implemented using one or more COBOL programs or sub programs.

Referring to FIGS. 1 and 2, a dialog management module 210 provides an interface between database management tools and a user, such as a user using terminal 130. This interface allows the user to provide information to the system necessary to implement a specific database management task. For example, the dialog management module 210 may be developed using the interactive system productivity facility (ISPF) dialog manager, which is part of the operating system of an IBM mainframe computer, such as mainframe computer 110. The ISPF dialog manager provides different kinds of services to dialogs while they are running and also controls the interaction of the dialog's elements. For example, ISPF can issue requests for panels to be displayed or screens to be formatted. These screens would be tailored to support the required operation, such as database management. Examples of such screens are discussed in detail below, in association with FIGS. 7 and 8.

FIG. 3 illustrates example software architecture of the database management system tools specific to a work to stage process, according to certain exemplary embodiments. Referring to FIGS. 1, 2, and 3, the architecture 300 depicts the relationship of individual subcategories of database management tools and specific tasks within those subcategories.

The dialog management module 210 provides dialog elements for each sub-category of database management tools. These subcategories are selected on the IMS DBA Tools Primary Menu 600 for specified environment which includes DBA (Database Administrators) Database Maintenance (WORK TO STAGE) 220, IMS Fast Path Utilities 230, Other IMS Functions 240, Management Reports 250, DB (Database) Tutorial 260, Display Messages 270, Code Migration 280. Through the panels, or screens, presented to a user, such as a user at terminal 130, the dialog management module 210 provides the necessary interaction between the user and the database management tools. As such, the dialog management module 210 provides the user with access, in a centralized location, to the tools.

In the exemplary embodiment of FIG. 3, DBA Database Maintenance (WORK TO STAGE) subcategory 220 allows for the maintenance of datasets used by DBAs to maintain and support databases, such as IMS databases. Also, this option allows a user to create JCL used during implementation of DBA modifications to the databases. The exemplary tasks for DBA Database Maintenance subcategory 220 include automated production of JCL tasks to perform based on proposed (WORK) modifications compared to current (STAGE) modifications; combination of automated production of JCL tasks with existing JCL (SHOTGUN JCL); Execution of Fast Path Area definition and population of randomizer table in proposed (WORK) JCL library; Clear proposed (WORK) JCL libraries of existing content; Verify client numbers in proposed (WORK) and current (STAGE) prior to implementing modifications. The DBA Database Maintenance subcategory 220 of automated production of JCL tasks based on proposed (WORK) modifications compared to current (STAGE) modifications is described in greater detail below, in conjunction with FIGS. 4-6.

The operations of the database management system tools are described in greater detail below in association with FIGS. 4-6. Accordingly, turning now to FIGS. 4-6, these figures include flow charts that illustrate the process of the database management system tools for automated work to stage database management. Although specific operations are disclosed in the flowcharts illustrated in FIGS. 4-6, such operations are exemplary. That is, embodiments of the present invention are well suited to performing various other operations or variations of the operations recited in the flowcharts. It is appreciated that the operations in the flowcharts illustrated in FIGS. 4-6 may be performed in an order different than presented, and that not all of the operations in the flowcharts may be performed.

All, or a portion of, the embodiments described by the flowcharts illustrated in FIGS. 4-6 can be implemented using computer-readable and computer-executable instructions which reside, for example, in computer-usable media of a computer system or like device. As described above, certain processes and operations of the present invention are realized, in one embodiment, as a series of instructions (e.g., software programs) that reside within computer readable memory of a computer system and are executed by the processor of the computer system. When executed, the instructions cause the computer system to implement the functionality of the present invention as described below.

FIGS. 4-6 will be described making reference to FIGS. 7 and 8 as necessary. Turning now to FIG. 4, this figure is a flow chart that illustrates the automated work to stage process, according to certain exemplary embodiments. The automated work to stage process begins at operation 402. In operation 404, a user may be provided with an IMS DBA Tools screen 700 as illustrated in FIG. 7.

Turning now to FIG. 7, this figure illustrates an example screen image depicting a primary selection screen, according to certain exemplary embodiments. In operation 402 of FIG. 4, the user may be provided with a primary menu 701 that displays names of the tasks or categories of tasks associated with the database management system tools. In the example screen image of FIG. 7, the dialog screen 700 allows a user to input a selection for a specific task. In this example, the alphanumeric value “1” is manually input by the user at point 702 to select the “Build Work to Stage JCL” category seen at item 703. Upon selecting the “Build Work to Stage JCL,” category, the user is presented with the display screen that corresponds to the “Build Work to Stage JCL,” category illustrated in FIG. 8A.

Turning now to FIG. 8A, this figure illustrates an example screen image depicting a database maintenance screen for a “Build Work to Stage JCL,” process, in accordance with an exemplary embodiment. Referring to FIG. 8A, the item 801 displays the name of the task or category of tasks. In this example, the category of task is WORK to STAGE Menu as seen in item 801. The dialog screen 800 allows a user to input selection for a specific task. In this example, the alphanumeric value “1” is manually input by the user at point 802. This entry corresponds to menu item “Automated WORK to STAGE,” seen at item 803. Upon selecting the “Automated Work to Stage,” category, the user is presented with the display screen that corresponds to the “Automated Work to Stage,” category illustrated in FIG. 8B.

Turning now to FIG. 8B, this figure illustrates an example screen image depicting a database maintenance screen for “Automated Work to Stage,” process, in accordance with an exemplary embodiment. Referring to FIG. 8B, the item 806 displays the name of the task, “Generate WORK to STAGE Jobs.” The 805 screen associated with the selected “Automated Work to Stage,” category prompts the user to enter the work database source file name and the stage database source file name. In other words, the user is prompted to input the old database source file and the new database source file. Accordingly, in operation 402 of FIG. 4, the user inputs the old database source file and the new database source file. Further, the user identifies or enters an output file name/dataset name to which the output JCL is to be written as shown by the Outage JCL DSN (Dataset Name) item in FIG. 8B. In addition, the user can enter outage control information, for example ‘bring down IMS,’ ‘bring down CICS,’ and ‘install over IPL,’ as illustrated in FIG. 8B.

Referring back to FIG. 4, when the user inputs the old database source file and the new database source file, in operation 404, the input/output engine 202 receives the old database source file and the new database source file and formats the files to a format preferred by the primary decision making engine 203. Responsive to formatting the files, the input/output engine 202 inputs the files to the compare engine 204 of the primary decision making engine 203. Upon receiving the formatted old and new database source files, in operation 406, the compare engine 204 starts a line by line comparison between the old and new database source files to identify any changes, such as additions, deletions, compressions, etc. One or ordinary skill in the art can understand and appreciate the changes detected by the compare engine 204 are not limited to the above-mentioned changes. The above-mentioned changes are representative example changes used for explanatory purposes, and numerous other appropriate changes can be identified by the compare engine 204 without departing from a broader scope of the disclosure.

Upon identifying a change, the compare engine 204 determines the type of change and the level at which the change has occurred, for example, if the change is at a database level, an area level, a segment level, and so on. Example type of changes can include, but is not limited to resize existing areas, add areas to an existing database, delete areas from an existing database, add a new segment to an existing database, and/or install a brand new set, new databases, areas, and segments.

Responsive to identifying the type and level of change, in operation 408, the compare engine 204 flags the change using a four character key. In particular, the compare engine program initiates a series of queries to identify the type and level of change. The four character key may represent a response to a query and not all responses are marked with the four character key. The queries may be based on a pre-determined order or priority. The order may be database level change followed by area level change and segment level change. In one example embodiment, the pre-determined order or priority may be user set. In one example embodiment, the pre-determined order may be generated based on a statistical analysis of changes. For example, upon statistically analyzing the changes over a period of time, assume that the most common change is identified as adding a new area. Accordingly, the first few queries may be focused on identifying area level changes and area level changes specific to adding new areas. This may increase the programs efficiency by being able to identify changes quickly and avoid numerous other queries. In another example embodiment, the pre-determined order may be based on client. For example, if the most common change associated with a client is compression change, then the queries may be tailored to first identify compression level changes. One of ordinary skill in the art can identify that the pre-determined order of questioning may be generated based on any appropriate factor.

For example, initially the compare engine 204 may query to identify if the database is a sequential database or a random database. Then, the compare engine 204 may query to identify if the change is a database level change. If the answer is no, then the compare engine 204 moves to the next question which asks if the change is an area level change. If the answer is a yes, then the compare engine 204 generates a four character unique key that represents the answer that the change is an area level change, e.g., ACHN. Then, the compare engine 204 may continue with additional queries to identify the type of change. Assuming the change is a compression change, the compare engine 204 generates a key representing the compression change, e.g., COMP. The compare engine 204 queries to identify if unload and reload operations are necessary to implement the compression change. In some embodiments, the compare engine 204 automatically knows that implementing a compression change requires unload and reload operations without the query. In either case, the compare engine 204 continues the series of queries to identify the specific areas associated with the compression change. Assuming only 10 areas of the database is associated with the compression change, the compare engine 204 generates keys associated with unload and reload operations for 10 areas, e.g., 10 UNLD and 10 RELD keys. Eventually, the example compression change produces 22 keys.

Example keys can include, but are not limited to, DBDN, DBDD, DBDC, DBYN, DBYD, DBYC, DBPN, DBPD, DBPC, NEWA, ADEL, CHNG, and so on, where DBD represents a fast path database, DBY represents an index database, DBP represents a full function database, A represents an area, N represents new (addition), D represents deletion, C represents change. As described above, each change can generate a number of keys.

Responsive to generating the one or more keys based on the identified change, in operation 410, the compare engine 204 sorts the keys into one or more files. Each key can exist in one or more files as found appropriate, and each file can have more than one key. In one embodiment, there is a separate file created based on all keys. For example, there would be a file 1 that included only records with the ‘COMP,’ key, file 2 which included only ‘NEWA,’ key, file 3 that includes ‘ADEL’ key, and file 4 could have both ‘DBDN’ and ‘DBDC’.

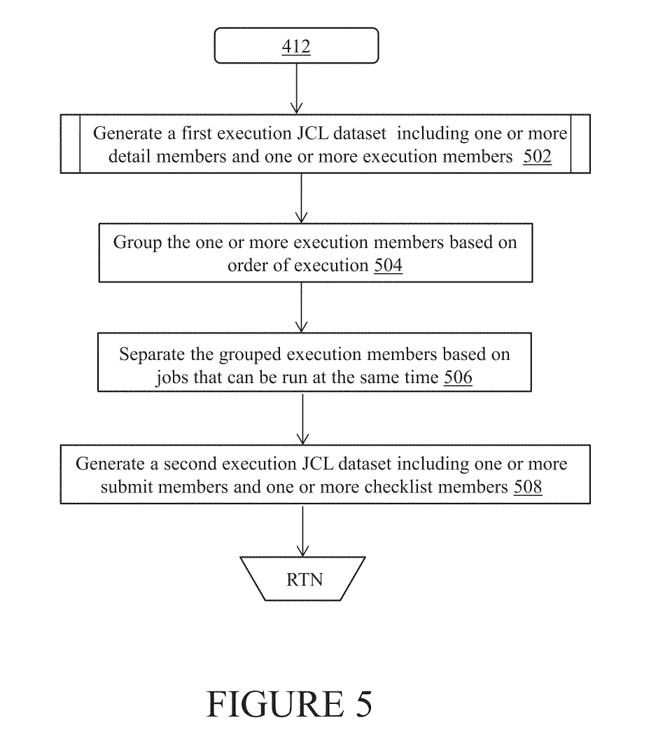

Once the keys are sorted into files, the compare engine 204 communicates the files to the dataset building engine 205. In operation 412, the dataset building engine 205 generates one or more executable JCL datasets based on the files formed using the keys. Operation 412 is described below in greater detail, in association with FIG. 5.

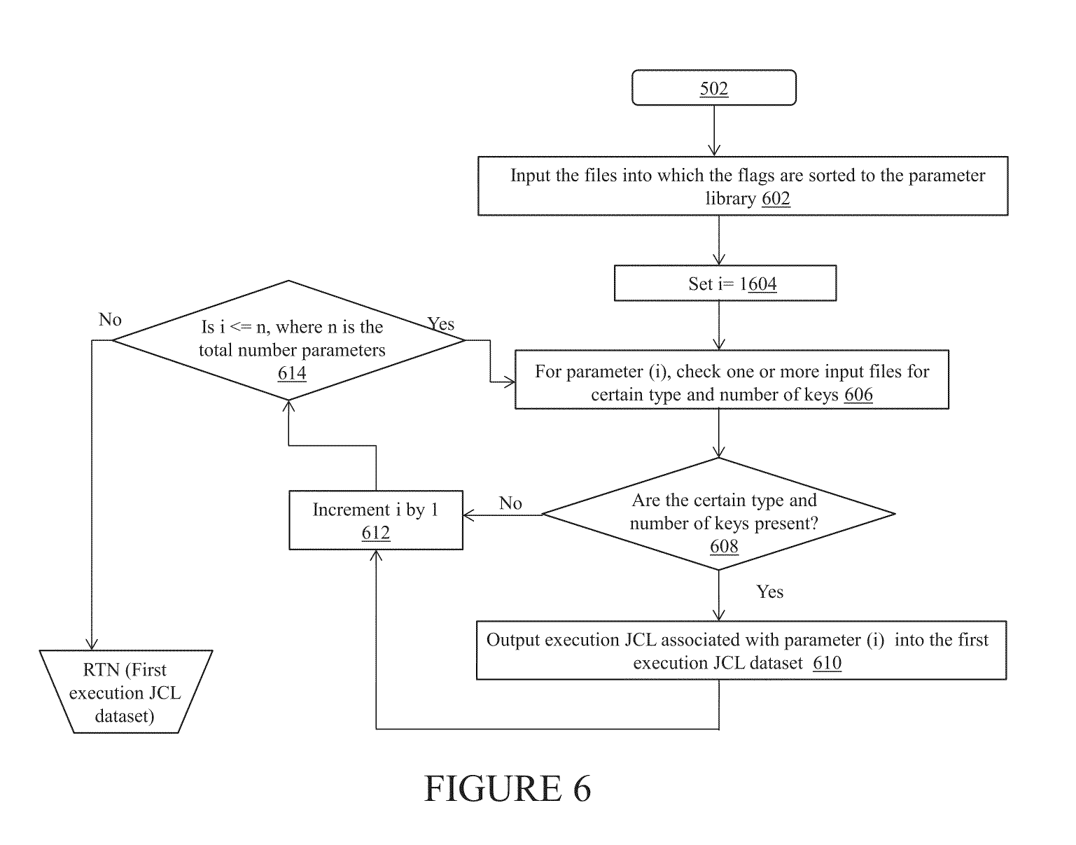

Turning now to FIG. 5, this figure is a flow chart that illustrates a process of generation of execution JCL datasets in the automated work to stage process of FIG. 4, according to certain exemplary embodiments. In operation 502, the dataset building engine 205 builds a first instructions dataset, e.g., first execution JCL dataset. Operation 502 is described below in greater detail, in association with FIG. 6.

Turning now to FIG. 6, this figure is a flow chart that illustrates a process of generation of first execution JCL dataset in the automated work to stage process of FIG. 5, according to certain exemplary embodiments. In operation 602, the files formed based on and comprising the keys are provided as input to a parameter library to generate the first execution JCL dataset. The parameter library includes skeletons for execution JCL's referred to as parameters. Once the files are provided as input, the dataset building engine 205 selects the first parameter from the parameter library. Accordingly, in operation 604, the dataset building engine 205 initializes a counter variable ‘i’ to 1. The counter variable ‘i’ represents the number of parameters in the parameter library. After initializing the counter variable to a value ‘1’ to select the first parameter, in operations 606 and 608, based on a logic associated with the first parameter, the dataset building engine 205 checks one or more of the input files for a certain number and type of keys. If the certain number and type of keys are present in the one or more input files that are checked in association with the first parameter, then, in operation 610, the dataset building engine 205 outputs execution JCL statements associated with the first parameter into the first execution JCL dataset. For example, if the first parameter include 5 execution JCLs and the conditions associated with the first parameter are met as described above, the dataset building engine 205 outputs the 5 execution JCLs to the first execution JCL dataset. The execution JCLs may be output for each area and/or segment based on the nature of the change. That is, if there are 4 areas and the change is associated with all 4 areas, then the dataset building engine 205 outputs 20 execution JCLs for the first parameter. Similarly, the dataset building engine 205 repeats operations 606-610 for each parameter of the parameter library by incrementing the counter variable ‘i’ by 1 for each iteration (operation 612) till all the parameters ‘n’ in the parameters library are covered (operation 614). Finally, after each parameter is covered, the first execution JCL dataset is generated. The first execution JCL dataset includes, but is not limited to, one or more detail members that provide a summary of all the changes that are to be implemented, and one or more execution members that describe the jobs required to implement the changes. Each execution member comprises one or more jobs, where each job is a collection of instructions, e.g., JCL statements. The generated first execution JCL dataset is returned to operation 504 of FIG. 5 where it is sent to the grouping engine 206.

Returning to FIG. 5, in operation 504, the grouping engine 206 separates the execution members of the first execution JCL dataset into groups based on an order of execution of jobs associated with the execution members, i.e., jobs that can executed while the environment is available for processing, jobs that can be executed while the environment is unavailable for processing, and jobs that can be executed during environment backup following an outage. The order of execution is determined using a 3-character identifier associated with each execution member. In particular, the first character of the three character identifier is a special character that represents the order of execution of the jobs associated with the execution member. For example, $ represents jobs that need to be run prior to outage, # represents jobs that need to be executed during outage, and @ represents jobs that need to be run after the outage. In said example, an execution member may have a three character identifier: $A0. Accordingly, the example execution member is grouped along with other executions members that have three character identifiers beginning with the $ symbol.

Responsive to grouping the execution members based on the order of execution of the jobs associated with the execution members, in operation 506, the grouping engine 206 further separates the grouped execution members within each group based on jobs that can be run at the same time or in parallel. This separation of the execution members in based on the letter value of the 3 character identifier, i.e., the second character of the three character identifier.

For example, assume that there are 8 execution members in the first execution JCL dataset, and the three character identifiers associated with each of the 8 execution members are $A0, #B2, $A1, @C0, #B2, @B1, #C0, #A2, $A0, and #C2. First, the grouping engine 206 groups the execution members based on an order of execution. Accordingly, the first grouping results in three groups based on the first character of the three character identifier, the first group comprising execution members having the three character identifiers $A0, $A1, and $A2; the second group comprising execution members having the three character identifiers #B2, #B2, #C0, #A2, and #C2; and the third group comprising execution members having the three character identifiers @C0 and @B1. Then, the execution members in each group is further grouped or separated based on jobs that can be executed in parallel. Accordingly, the second grouping is based on either one of or both the remaining characters of the three character identifier. The second grouping results in three separate groups for three separate execution members of the first group, and two separate groups for the two separate execution members of the third group since they cannot be executed in parallel. However, in the second group, the five execution members are separated into four categories, where the #B2 members' fall in one category since they can be executed in parallel, and the other three execution members form three separate categories.

Responsive to grouping the execution members of the first execution JCL dataset, the grouping engine 206 communicates with the dataset building engine 205 to build a second execution JCL dataset. The second execution JCL dataset includes an additional ‘.sub’ node added to the first execution JCL dataset members. In particular, the second execution JCL dataset includes, but is not limited to, one or more submit members and a checklist members that lists all the submit members that needs to be run. The submit member includes JCL statements to submit execution members from the first execution JCL dataset in parallel based on the three character identifier. Continuing with the above-mentioned example associated with grouping the execution members of the first execution JCL dataset, for the second group, the dataset building engine 205 generates four submit members for executing the five execution members. The submit members may be the #B2 submit member, the #C0 submit member, the #A2 submit member, and the #C2 submit member. All jobs that start with the #B2 prefix run together and will all be submitted from that #B2 submit member instead of having to make two separate submissions, one for each of the two #B2 execution members of the second group. In another example, if there are 10 #C0 execution members, the dataset building engine 205 generates one #C0 submit member for submitting the 10 #C0 execution members in parallel. The submit members can be generated based on the grouping of execution members in the first execution JCL dataset generated in operations 502-506.

The first and the second dataset, i.e., the first execution JCL dataset and the second execution JCL dataset may be outputted into a file specified by the user as described above in association with FIGS. 8A-8B. The output file may be presented to the user and the user can submit jobs for implementing the changes to the database using the submit members of the second execution JCL dataset. In an example embodiment, if the output dataset names specified by the user coincide with the name of an existing datasets, the user may be informed that the existing datasets will be deleted and created from scratch. Further, the user may be prompted to verify that the user wants to continue with the specified dataset names as illustrated in 812 and 813 of FIG. 8C. Referring to FIG. 8C, the item 810 displays the name of the task. In this example, the task is DATA SET VERIFICATION as seen in item 811. The dialog screen 810 allows a user to verify the Outage JCL DSN (Dataset Name) as seen in item 812. This screen provides the user with additional choices. For example, item 813 shows that a user may provide the alphanumeric letter “A” to Continue WORK to STAGE action.

Turning to FIG. 8D, this figure illustrates an example screen image 815 depicting a database maintenance screen, according to certain exemplary embodiment. Referring to FIG. 8D, as indicated by item 816, this screen image is for submitting the generated WORK to STAGE job. In this case, as indicated by item 817, the job will create task JCL for the Automated WORK to STAGE Process. Item 819 allows the user to enter required Job Card Information. This screen provides the user with additional choices. For example, item 818 shows that a user may enter “END” on the Command line to submit the job.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1) A method of a database management tool comprising:
identifying, by a computer, one or more changes between an old database source file and a new database source file based on a comparison of the old database source file against the new database source file;
generating, by the computer, one or more keys based on each identified change and sorting the one or more keys into one or more files;
based on the one or more files, building a first dataset comprising at least one of a summary of the one or more identified changes and a set of instructions representative of jobs associated with implementing the one or more identified changes;
responsive to building the first dataset, grouping the set of instructions in the first dataset based on an order of execution of the jobs and based on the jobs that are executable in parallel;
creating a second dataset comprising at least another set of instructions configured to submit one or more of the jobs represented by the set of instructions in the first dataset for execution in parallel.

2) The method of claim 1, wherein the step of grouping the set of instructions in the first dataset further comprising:
separating, by the computer, the set of instructions into a first group instructions that are executable before an outage time period, a second group instructions that are executable during the outage time period, and a third group of instructions that are executable after the outage time period; and
within each group, identifying and separating instructions that are executable in parallel.

3) The method of claim 1, wherein the set of instructions in the first dataset are grouped based on a three character identifier associated with the set of instructions.

4) The method of claim 1, wherein the instructions are written in Job Control Language (JCL).

5) The method of claim 1, wherein the step of identifying the one or more changes further comprising:
for each identified change, determining, by the computer, whether the change is at least at a database level, an area level, and a segment level; and
for each identified change, determining, by the computer, the type of change.

6) The method of claim 1, wherein the comparison of the old database source file against the new database source file comprises a series of queries based on which the one or more changes are identified.

7) The method of claim 1, further comprising: outputting the first and second dataset for presentation to a user.

8) The method of claim 1, wherein the step of building a first dataset further comprising: inputting, by the computer, the one or more files into a parameter library, wherein the parameter library comprises one or more parameters representative of skeleton instructions written in Job Control Language (JCL).

9) An apparatus comprising:
a memory; and
a processor coupled to the memory and configured to:
receive an old database source file and a new database source file associated with a database;
process the old database source file and the new database source file to identify one or more changes that are to be implemented in the database;
based on the one or more identified changes, generate:
a first dataset comprising at least one or more execution members and a details member, wherein each execution member comprises one or more jobs associated with implementing the identified change and the details member comprises a summary of the identified change, and wherein the one or more execution members are grouped based on an order of execution of the one or more jobs associated with the respective execution member and based on the one or more jobs that are executable in parallel; and
a second dataset comprising at least one or more submit members and a checklist member, wherein each submit member comprises instructions for submitting the one or more jobs that are executable in parallel, and wherein the checklist member comprises a list of the submit members for execution.

10) The apparatus of claim 9, wherein for grouping the one or more execution members, the processor is configured to:
separate the one or more execution members into groups based on the order of execution; and
separate the one or more grouped execution members of each group based on the grouped execution members that are executable in parallel.

11) The apparatus of claim 9, wherein the groups based on the order of execution comprise at least a group of execution members having jobs that are executable prior to an outage time period, a group of execution members having jobs that are executable during the outage time period, and a group of execution members having jobs that are executable after the outage time period.

12) The apparatus of claim 9, wherein for processing the old database source file and the new database source file to identify one or more changes, the processor is configured to:
compare the old database source file against the new database source file to identify the one or more changes between an old database source file and a new database source file;
generate one or more keys based on each identified change;
sorting the one or more keys into one or more files; and
input the one or more files into a parameter library, wherein the parameter library comprises one or more parameters representative of skeleton instructions written in Job Control Language (JCL).

13) The apparatus of claim 9, wherein the grouping the one or more execution members in the first dataset is based on a three character identifier associated with each of the one or more execution members of the first dataset.

14) A non-transitory computer-readable storage medium comprising a database management system tools program for causing a computer that includes a processor and a memory to execute an automated work to stage process, the database management system tools program causing the computer to:
identify one or more changes between an old database source file and a new database source file based on a comparison of the old database source file against the new database source file;
generate one or more keys based on each identified change and sorting the one or more keys into one or more files;
based on the one or more files, build a first dataset comprising at least a summary of the one or more identified changes and one or more execution members, each execution member comprising one or more jobs associated with implementing the one or more identified changes, and each job comprising a set of instructions;
responsive to building the first dataset, group the one or more execution members in the first dataset based on an order of execution of the one or more jobs associated with each execution member and based on the one or more jobs that are executable in parallel;
create a second dataset comprising at least one or more submit members, wherein each submit member is associated with a respective group of execution members in the first dataset that are executable in parallel, and wherein each submit member comprises another set of instructions configured to submit, for execution, one or more jobs associated with the group of execution members of the first dataset that are executable in parallel.

15) The non-transitory computer-readable storage medium of claim 14, wherein to group the one or more execution members in the first dataset, the database management system tools program causes the computer to:
separate the one or more execution members into a first group representing jobs that are executable before an outage time period, a second group representing jobs that are executable during the outage time period, and a third group representing jobs that are executable after the outage time period; and
identify and separate, within each group, jobs that are executable in parallel.

16) The non-transitory computer-readable storage medium of claim 14, wherein the one or more execution members are grouped based on a three character identifier associated with each execution member.

17) The non-transitory computer-readable storage medium of claim 14, wherein to identify the one or more changes, the database management system tools program causes the computer to:
determine, for each identified change, whether the change is at least at a database level, an area level, and a segment level; and
determine, for each identified change, the type of change.

18) The non-transitory computer-readable storage medium of claim 14, wherein the comparison of the old database source file against the new database source file comprises a series of queries based on which the one or more changes are identified.

19) The non-transitory computer-readable storage medium of claim 14, wherein the database management system tools program causing the computer to: output the first and second dataset for presentation to a user.

20) The non-transitory computer-readable storage medium of claim 14, wherein to build a first dataset, the database management system tools program causes the computer to: input the one or more files into a parameter library, wherein the parameter library comprises one or more parameters representative of skeleton instructions written in Job Control Language (JCL).
